(19) United States
(12) Patent Application Publication
(10) Pub. No.: US 2026/0291218 A1
(43) Pub. Date: Sep. 24, 2026

(54) HYBRID VOLTAGE LIMITER

(71) Applicant: Hitachi Energy Ltd, Zürich (CH)

(72) Inventor: Julian Josephsohn, Zürich (DE)

(21) Appl. No.: 18/997,993

(22) PCT Filed: Aug. 10, 2022
(86) PCT No.: PCT/EP2022/072489

§ 371 Date: Jan. 23, 2025

(51) Int. Cl. H02H 9/04; H01C 7/10

(52) U.S. Cl. CPC H02H 9/04; H01C 7/10

(57) ABSTRACT

The present disclosure relates to a hybrid voltage limiter that includes a first electrode, a second electrode, trigger electronics, a thyristor component and a varistor component which comprises a varistor and which is connected in parallel with the thyristor component, wherein the thyristor component is galvanically connected to the first electrode, the thyristor component is formed with two thyristors connected in antiparallel, the gates of the antiparallel-connected thyristors are connected to the trigger electronics, wherein the trigger electronics are galvanically connected to the first electrode and the second electrode, the thyristor component is galvanically connected to the second electrode via a first resistivity, the thyristor component is galvanically connected to the second electrode by a bypass having a second resistivity, and the bypass is connected to the second electrode in such a way that a spark gap is avoided and the varistor component is galvanically connected to the first electrode and the second electrode.

### CROSS REFERENCE TO RELATED APPLICATIONS

This application is a 35 U.S.C. § 371 national stage application of PCT International Application No. PCT/EP2022/072489 filed on Aug. 10, 2022, the disclosure and content of which is incorporated by reference herein in its entirety.

### TECHNICAL FIELD

The present disclosure relates to a hybrid voltage limiter comprising a first electrode, a second electrode, trigger electronics, a thyristor component and a varistor component which comprises a varistor and which is connected in parallel with the thyristor component, wherein the thyristor component is galvanically connected to the first electrode, the thyristor component is formed with two thyristors connected in antiparallel, the gates of the antiparallel-connected thyristors are connected to the trigger electronics in such a way that a trigger signal of the trigger electronics can be received, wherein the trigger electronics are galvanically connected to the first electrode and the second electrode, the thyristor component is galvanically connected to the second electrode, the thyristor component is galvanically connected to the second electrode, and the varistor component is galvanically connected to the first electrode and the second electrode.

### BACKGROUND

Hybrid voltage limiters consist of a parallel connection of a metal-oxide varistor and two anti-parallel connected thyristors. The metal-oxide varistor limits transient overvoltages caused by lightning and switching operations in the network. If overvoltages occur for a longer period of time (milliseconds up to hours) as a result of faults in the network or for operational reasons, the thyristors ignite and thus limit the transient voltages. As soon as a current zero crossing occurs, the thyristors extinguish the current flow and the original state is restored. As soon as the current is zero the thyristors cancel the current flow and the original state is restored. Typically, the varistor circuit and the thyristor circuit are assembled one on top of the other and they are insulated with a composite material plate and connected to the electrodes with bolts. This means that all the current flowing through each parallel circuit is then flowing through each set of bolts. The problem is that when the current is too high, a dielectric breakdown due to the small distances between the bolts and the electrode may occur. Usually, this results in an instantaneous meltdown of the bolt and electrode.

### SUMMARY

It is therefore the object of the present disclosure to provide a hybrid voltage limiter which shows improved operability.

In some embodiments, the object is solved by a hybrid voltage limiter comprising a first electrode, a second electrode, trigger electronics, a thyristor component and a varistor component which comprises a varistor and which is connected in parallel with the thyristor component, wherein the thyristor component is galvanically connected to the first electrode, the thyristor component is formed with two thyristors connected in antiparallel, the gates of the antiparallel-connected thyristors are connected to the trigger electronics in such a way that a trigger signal of the trigger electronics can be received, wherein the trigger electronics are galvanically connected to the first electrode and the second electrode, the thyristor component is galvanically connected to the second electrode via a first resistivity, the thyristor component is galvanically connected to the second electrode by a bypass having a second resistivity, the first resistivity has a higher resistance value than the second resistivity, and the bypass is connected to the second electrode in such a way that a spark gap is avoided and the varistor component is galvanically connected to the first electrode and the second electrode.

Therefore, according to the present disclosure, the second resistivity has a lower resistivity value than the first resistivity. This indirectly sets the path for the bulk of the power to be collected by the thyristor component. The current flows preferentially along the lowest resistance to the second electrode. Further, by avoiding spark gaps between the bypass and the second electrode, the possibility of a dielectric breakdown due to material having a lower dielectric constant is avoided. The spark gap is the space between two conductive surfaces that can be overcome at a sufficiently high voltage so that discharge can take place.

In general, the bypass can be designed in different ways. In some embodiments, however, it is provided that the bypass has a first contact surface and a second contact surface, the second surface being located on a side opposite the first contact surface, wherein an edge of the first contact surface is galvanically connected via a connection to an edge of the second contact surface. This makes it possible to integrate the bypass into the hybrid voltage limiter without negatively affecting the design and at the same time allowing a high current flow.

In some embodiments, it is provided that the second contact surface of the bypass is circular and the connection of the two contact surfaces has a width corresponding to the diameter of the second contact surface. The width of the connecting piece, which corresponds to the diameter of the second contact surface, prevents the formation of edges and corners on the bypass and thus reduces the edges and corners and by that the surface that would be suitable for a spark gap. The same applies to the circular shape of the second contact surface, which ensures a constant distance to other conductors.

In some embodiments, it is provided that the bypass has a curved shape that is C-shaped in cross-section and the first contact surface corresponds to the lower part of the shape, the connection corresponds to the middle part and the second contact surface corresponds to the upper part. This allows the varistor component to be accommodated in the open arc of the C-shape, thus ensuring a compact and robust structure.

In some embodiments, it is provided that the thickness of the bypass is constant along its length. The constant thickness of the bypass ensures a constant resistance in the bypass and reduces the surface area that could otherwise be susceptible to a spark gap.

It is possible that the bypass is made of different materials and material compositions as long as the resistivity of the material has a lower value than that of the first resistivity. In some embodiments, however, it is provided that the bypass comprises aluminum. The aluminum has a lower resistivity than the first resistivity and thus conducts the current better to the electrode, preventing dielectric breakdown.

In some embodiments, it is provided that the bypass comprises copper. The copper has a lower resistivity than the first resistivity and therefore conducts the current better to the electrode, preventing dielectric breakdown.

In some embodiments, it is provided that an angle of 90° is formed between the first contact surface and the connection and an angle of 94° is formed between the second contact surface and the connection. Due to the slightly enlarged angle between the second contact surface and the connection, there is a larger space to accommodate the varistor plate.

In principle, the hybrid voltage limiter can be designed in several ways. In some embodiments, however, it is provided that the first electrode is located on a side opposite to the second electrode, and the thyristor component is located between the first electrode and the second electrode, wherein the thyristor component is in galvanically connective contact with the first electrode, wherein the thyristor component further comprises a thyristor plate arranged on the side facing the second electrode at the first contact surface of the bypass and an isolation plate and the varistor component are arranged between the first and the second contact surface of the bypass, the varistor component further comprises a varistor plate facing the isolation plate and the first contact surface, the varistor is arranged on the side of the second contact surface facing the first contact surface, the side of the second contact surface of the bypass facing the second electrode is arranged on the second electrode, the varistor plate is connected to the first electrode by attachment means, the thyristor plate is connected to the second electrode by attachment means, and the attachment means have the first resistivity. Placing the individual components in this way ensures a compact design that also minimizes the risk of dielectric breakdown at the contacting point between the electrode and the thyristors' circuit attachment means.

In general, the thyristor plate and the varistor plate can be attached to the electrodes in different ways. In some embodiments, however, it is provided that the attachment means are screws and the side of the second electrode facing the first electrode has sockets with internal threads for receiving the screws, which are applied to the surface of the second electrode, so that the second electrode has no holes facing the first electrode. By not having any holes or interfaces interrupting the surface of the second electrode opposite the first electrode, no space is revealed for a spark gap that could lead to dielectric breakdown if attachment means were placed in the second electrode.

In some embodiments, it is provided that the first contact surface of the bypass has a triangular shape, wherein the first contact surface has a larger area than the second contact surface, and the two corners of the triangular contact surface facing away from the connection each have a through hole.

It is possible, that the bypass is inserted into the hybrid voltage limiter in various ways. In some embodiments, however, it is provided that the through holes in the corners of the first contact surface of the bypass receive the screws that connect the thyristor plate to the second electrode.

In principle, different varistor types may be used for the present disclosure. In some embodiments, however, it is provided that the varistor is a metal oxide varistor. Metal oxide varistors exhibit almost absolute absence of current up to a certain potential difference.

In general, the trigger electronics can be located in different places. In some embodiments, however, it is provided that the first contact surface of the bypass has a centrally located through hole and the isolation plate has a centrally located through hole, a varistor plate recess is formed in the side of the varistor plate facing the second electrode, the trigger electronics are arranged in the varistor plate recess of the varistor plate, a through-thyristor-plate-recess is formed in the thyristor plate and the trigger electronics are connected to the thyristors through the thyristor plate by means of the through-thyristor-plate-recess. This allows the trigger electronics to be placed between the thyristor plate and the varistor plate.

It is possible that the space between the electrodes is filled with different materials. In some embodiments, however, it is provided that the space formed between the first electrode and the second electrode is filled with silicone. Filling the space between the two electrodes with silicone improves the resistance of the component to external influences such as vibrations, temperature fluctuations and changes in humidity.

In some embodiments, it is provided that the space formed between the first electrode and the second electrode is filled with epoxy resin.

Further implementations and advantages of the method are directly and unambiguously derived by the person skilled in the art from the system as described before.

### BRIEF DESCRIPTION OF DRAWINGS

These and other aspects of the present disclosure will be apparent from and elucidated with reference to the implementations described hereinafter.

In the drawings:

FIG. 1 shows a schematic side view of the hybrid voltage limiter according to an embodiment of the present disclosure,

FIG. 2 shows a schematic cross-sectional view of the hybrid voltage limiter according to an embodiment of the present disclosure, and

FIG. 3 shows a schematic view of the bypass of the hybrid voltage limiter according to an embodiment of the present disclosure.

### DETAILED DESCRIPTION

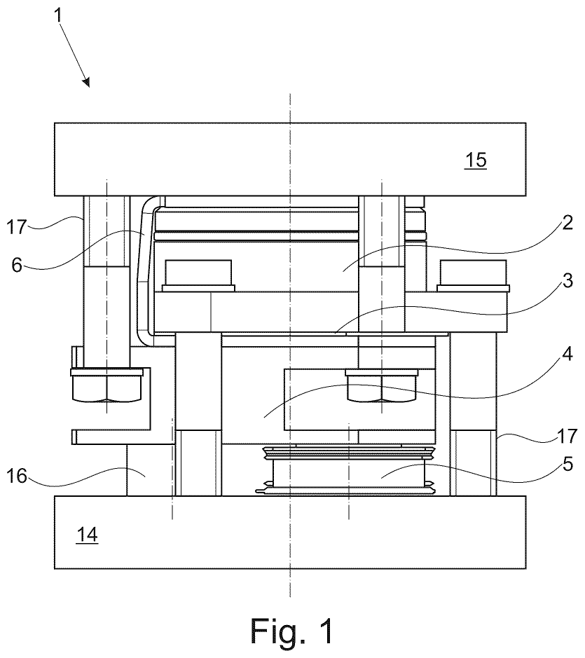

FIG. 1 shows a schematic side view of a hybrid voltage limiter 1. The hybrid voltage limiter 1 is cylindrical and a first electrode 14 and a second electrode 15 form the boundaries along the central axis of the cylindrical hybrid voltage limiter 1. The central axis of the hybrid voltage limiter 1 is perpendicular to the first electrode 14 and the second electrode 15. The individual electrodes are also cylindrical and have contacting options on the opposite sides facing away from each other, which are not shown in the figures. Antiparallel connected thyristors 5 are anchored in the first electrode 14 via pins, which are also not shown in the figures, and are conductively connected to it. A thyristor plate 4 is placed on the thyristors 5, which, analogous to the first electrode 14, is also designed with holes for receiving pins from the thyristors 5. The thyristors 5 and the thyristor plate 4 form a thyristor component. The thyristor plate 4 is connected to the first electrode 14 via an isolation piece 16 surrounding the thyristors 5 on its outer side. The thyristor plate 4 has holes for receiving screws 13 which connect the thyristor plate 4 to the second electrode 15. This connection is ensured by the sockets 17 placed on the second electrode 15, which are correspondingly provided with an internal thread for receiving the screws 13, whereby no hole with an internal thread is required on the side of the second electrode 15 facing the first electrode 14 for fastening.

A bypass 6 is galvanically connected with a first contact surface 18 resting on the thyristor plate 4. The first contact surface 18 of the bypass 6 has through holes 24 for receiving the screws 13, so that the bypass 6 is also firmly connected to the thyristor plate 4. An isolation plate 3 is attached to the side of the first contact surface 18 of the bypass 6 facing the second electrode 15. A varistor plate 2 is placed on the isolation plate 3, which also has holes for receiving screws 13. The screws 13 thus serve, in a manner analogous to the thyristor plate 4 and the second electrode 15, to connect the varistor plate 2 to this first electrode 14 via internally threaded sockets 17, which are attached to the first electrode 14.

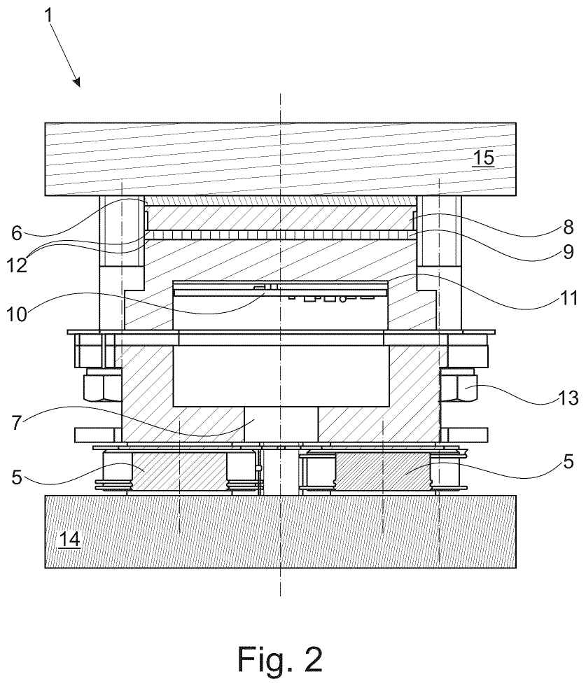

FIG. 2 schematically shows a sectional view of the hybrid voltage limiter 1. It can be seen here that the bypass 6 encloses the varistor component consisting of a varistor 9 and the varistor plate 2. The bypass 6 also encloses contact washers 12, the isolation plate 3 and a spacer 8. The varistor component is galvanically connected to a second contact surface 19 of the bypass 6 via the contact washers 12 and the spacer 8. The second contact surface 19 is in turn galvanically connected to the second electrode 15. Both the varistor plate 2 and the thyristor plate 4 have internal recesses for accommodating trigger electronics 10. The first contact surface 18 of the bypass 6 has a centrally located through hole 23. The isolation plate 3 also has a centrally arranged through hole. The trigger electronics 10 are galvanically isolated from the varistor plate 2 via a disc of mica 11. The trigger electronics 10 is connected through cables (not shown) to the gate and cathode of each thyristor 5. The cables are fed through a centrally located through-thyristor-plate-recess 7 in the recess of the thyristor plate 4.

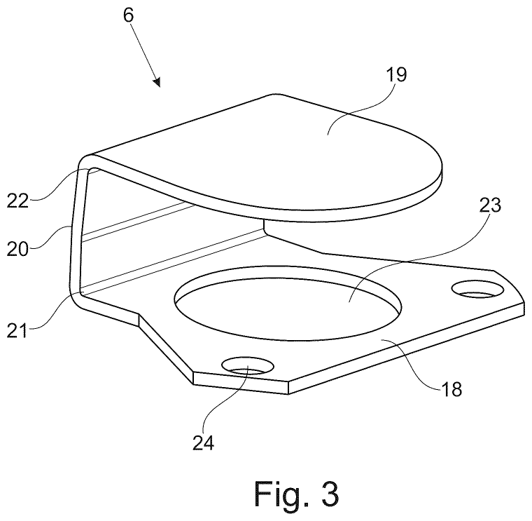

Finally, in FIG. 3, the bypass 6 of the hybrid voltage limiter 1 is shown. The bypass 6 has a C-shaped cross-section so that the isolation plate 3, the varistor plate 2, the contact washer 12, the varistor 9, and the second contact washer 12 as well as the spacer 8 are enclosed by the first contact area 18 and the second contact area 19. The first contact surface 18 and the second contact surface 19 are galvanically connected via a connection 20. The first contact surface 18 and the connection 20 form an angle of 90° 21. The second contact surface 19 and the connection 20 form an angle of 94° 22. The first contact surface 18 of the bypass 6 has a basically triangular shape. The corner facing the connection 20 is cut off. The two corners of the bypass 6 opposite the connection 20 have the through holes 24 for receiving the screws 13. The second contact surface 19 of the bypass 6 is circular on the side facing away from the connection 20. On the side facing the connection 20, from the center of the circular second contact surface 19, there is a continuous connection to the connection 20 with the width of the diameter of the second contact surface 19. This width is maintained over the entire connection 20 between the first contact surface 18 and the second contact surface 19.

Starting from the first electrode 14, a current can flow via the thyristors 5 and the thyristor plate 4 to the first contact surface 18 of the bypass 6. At the same time, a current can flow from the first electrode 14 via the screws 13 towards the varistor plate 2, the trigger electronics 10 and the varistor 9. Starting from the second electrode 15, a current can flow via the second contact surface 19 of the bypass 6 to the varistor 9, the varistor plate 2 and the trigger electronics 10. Likewise, a current can flow from the second electrode 15 via the screws 13 to the thyristor plate 4. At the same time, however, a current can flow from the second electrode 15 via the second contact surface 19, the connection 20 and the first contact surface 18 to the thyristor plate 4. Due to the lower resistivity of the aluminum bypass 6 and the flat contacting at the thyristor plate 4 and the second electrode 15, the current will always prefer this direction of flow to that through the screws 13 to the thyristor plate 4.

While the present disclosure has been illustrated and described in detail in the drawings and foregoing description, such illustration and description are to be considered illustrative or exemplary and not restrictive; the present disclosure is not limited to the disclosed implementations. Other variations to be disclosed implementations can be understood and effected by those skilled in the art in practicing the disclosed subject matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 hybrid voltage limiter
2 varistor plate
3 isolation plate
4 thyristor plate
5 thyristors
6 bypass
7 through-thyristor-plate-recess
8 spacer
9 varistor
10 trigger electronics
11 disc of mica
12 contact washers
13 screw
14 first electrode
15 second electrode
16 isolation piece
17 sockets
18 first contact surface
19 second contact surface
20 connection
21 angle of 90°
22 angle of 94°
23 centrally located through hole
24 through hole

1. A hybrid voltage limiter comprising a first electrode, a second electrode, trigger electronics, a thyristor component and a varistor component which comprises a varistor and which is connected in parallel with the thyristor component, wherein
the thyristor component is galvanically connected to the first electrode,
the thyristor component is formed with two thyristors connected in antiparallel,
the gates of the antiparallel-connected thyristors are connected to the trigger electronics in such a way that a trigger signal of the trigger electronics can be received, wherein
the trigger electronics are galvanically connected to the first electrode and the second electrode,
the thyristor component is galvanically connected to the second electrode via a first resistivity,
the thyristor component is galvanically connected to the second electrode by a bypass having a second resistivity,
the first resistivity has a higher resistance value than the second resistivity, and
the bypass is connected to the second electrode in such a way that a spark gap is avoided and
the varistor component is galvanically connected to the first electrode and the second electrode

2. The hybrid voltage limiter according to claim 1, wherein the bypass has a first contact surface and a second contact surface, the second surface being located on a side opposite the first contact surface, wherein an edge of the first contact surface is galvanically connected via a connection to an edge of the second contact surface.

3. The hybrid voltage limiter according to claim 2, wherein the second contact surface of the bypass is circular and the connection of the two contact surfaces has a width corresponding to the diameter of the second contact surface.

4. The hybrid voltage limiter according to claim 2, wherein the bypass (6) has a curved shape that is C-shaped in cross-section and the first contact surface corresponds to the lower part of the shape, the connection corresponds to the middle part and the second contact surface corresponds to the upper part.

5. The hybrid voltage limiter according to claim 2, wherein an angle of 90° is formed between the first contact surface and the connection and an angle of 94° is formed between the second contact surface and the connection.

6. The hybrid voltage limiter according to claim 1, wherein the thickness of the bypass is constant along its length.

7. The hybrid voltage limiter according to claim 1, wherein the bypass comprises aluminum.

8. The hybrid voltage limiter according to claim 1, wherein the bypass comprises copper.

9. The hybrid voltage limiter according to claim 8, wherein the first electrode is located on a side opposite to the second electrode, and
the thyristor component is located between the first electrode and the second electrode, wherein
the thyristor component is in galvanically connective contact with the first electrode, wherein
the thyristor component further comprises a thyristor plate arranged on the side facing the second electrode at the first contact surface of the bypass and
an isolation plate and the varistor component are arranged between the first and the second contact surface of the bypass,
the varistor component further comprises a varistor plate facing the isolation plate and the first contact surface,
the varistor is arranged on the side of the second contact surface facing the first contact surface,
the side of the second contact surface of the bypass facing the second electrode is arranged on the second electrode,
the varistor plate is connected to the first electrode by attachment means,
the thyristor plate is connected to the second electrode by attachment means, and the attachment means have the first resistivity.

10. The hybrid voltage limiter according to claim 9, wherein the attachment means are screws and the side of the second electrode facing the first electrode has sockets with internal threads for receiving the screws, which are applied to the surface of the second electrode, so that the second electrode has no holes facing the first electrode.

11. The hybrid voltage limiter according to claim 10, wherein the first contact surface of the bypass has a triangular shape, wherein the first contact surface has a larger area than the second contact surface, and the two corners of the triangular contact surface facing away from the connection each have a through hole.

12. The hybrid voltage limiter according to claim 11, wherein the through holes in the corners of the first contact surface of the bypass receive the screws that connect the thyristor plate to the second electrode.

13. The hybrid voltage limiter according to claim 1, where the varistor is a metal oxide varistor.

14. The hybrid voltage limiter according claim 2, wherein the first contact surface of the bypass has a centrally located through hole and the isolation plate has a centrally located through hole,
a varistor plate recess is formed in the side of the varistor plate facing the second electrode,
the trigger electronics are arranged in the varistor plate recess of the varistor plate,
a through-thyristor-plate-recess is formed in the thyristor plate and
the trigger electronics are connected to the thyristors through the thyristor plate by means of the through-thyristor-plate-recess.

15. The hybrid voltage limiter according to claim 1, wherein the space formed between the first electrode and the second electrode is filled with silicone.
